(19) United States
(12) Patent Application Publication
(10) Pub. No.: US 2017/0309004 A1
(43) Pub. Date: Oct. 26, 2017

(54) IMAGE RECOGNITION USING DESCRIPTOR PRUNING

(71) Applicant: THOMSON LICENSING, Issy les Moulineaux (FR)

(72) Inventors: Joaquin ZEPEDA SALVATIERRA, Saint Didier (FR); Aakanksha RANA, Rennes (FR); Patrick PEREZ, RENNES (FR)

(73) Assignee: THOMSON LICENSING, Issy les Moulineaux (FR)

(21) Appl. No.: 15/509,973

(22) PCT Filed: Aug. 25, 2015
(86) PCT No.: PCT/EP2015/069452

§ 371 Date: Mar. 9, 2017

(30) Foreign Application Priority Data
Sep. 9, 2014 (EP) 14306386.5

(51) Int. Cl. G06T 5/20; G06K 9/46

(52) U.S. Cl. CPC G06T 5/20; G06K 9/4676; G06T 2207/20081

(57) ABSTRACT

The present disclosure relates to image recognition or image searching. More precisely, the present disclosure relates to pruning local descriptors extracted from an input image. The present disclosure proposes a system, method and device directed to the pruning of local descriptors extracted from image patches of an input image. The present disclosure prunes local descriptors assigned to a codebook cell, based on a relationship of the local descriptor and the assigned codebook cell. The present disclosure includes assigning a weight value for use in pruning based on the relationship of the local descriptor and the assigned codebook cell. This weight value is then used during the encoding of the local descriptors for use in image searching or image recognition.

### TECHNICAL FIELD

The present disclosure relates to image recognition or search techniques. More precisely, the present disclosure relates to pruning of local descriptors that are encoded for image searching.

### BACKGROUND

Various computer or machine based applications offer the ability to perform image searches. Image searching involves searching for an image or images based on the input of an image or images. Image searching is relevant in many fields, including the fields of computer vision, object recognition, video tracking, and video-based location determination/mapping.

FIG. 1A illustrates a standard image process for image searching 100. The standard image process for image searching 100 includes (i) receiving input image(s) 110 that will be the basis of the image search; (ii) extracting local image descriptors 120 from the inputted image(s); (iii) encoding the extracted local image descriptors into global image feature vector 130; and (iii) performing image searching by comparing the global image feature vector of the inputted image to image feature vectors of the images in a collection of search images 140.

FIG. 1B illustrates an example of the extracting local image descriptors process 120. The extraction process receives an input image 121 and computes local image patches 122 for that image. FIG. 1C shows an example of patches 125 computed using a regular grid dense detector. FIG. 1D shows an alternate example of patches 126 computed using a sparse detector such as a Difference-of-Gaussians (DoG) or Hessian Affine local detector.

Once the local images patches are computed at block 122, block 123 computes the local descriptor for each of the image patches. Each local descriptor may be computed using an algorithm for each patch, such as the Scale Invariant Feature Transform (SIFT) algorithm. The result is a local descriptor vector (e.g., a SIFT vector xᵢ of size 128) for each patch. Once a local descriptor vector has been computed for each image patch, the resulting set of local descriptor vectors are provided for further processing at block 124. Examples of discussions of local descriptor extractions include: David Lowe, Distinctive Image Features From Scale Invariant Keypoints, 2004; and K. Mikolajczyk, A Comparison of Affine Region Dectors, 2006.

Block 130 may receive the local descriptors computed at block 120 and encode these local descriptors into a single global image feature vector. An example of a discussion of such encoders is in Ken Chatfield et al., The devil is in the details: an evaluation of recent feature encoding methods, 2011. Examples of image feature encoders include: bag-of-words encoder (an example of which is Josef Sivic et al., Video Google: A Text Retrieval Approach to Object Matching in Videos, 2003); Fisher encoder (an example of which is Florent Perronnin et al., Improving the Fisher Kernel for Large-Scale Image Classification, 2010), and VLAD encoder (example of which is Jonathan Delhumeau et al., Revisiting the VLAD image representation, 2013).

These encoders depend on the specific models of distribution of the local descriptors obtained in block 120. For example the Bag-of-Words and VLAD encoders use a codebook model obtained using K-means, while the Fisher encoder is based on a Gaussian Mixture Model (GMM).

Block 140 may receive the global feature vector computed at block 130 and perform image searching 140 on the global feature vector. Image search techniques can be broadly split into two categories, semantic search or image retrieval. FIG. 1E illustrates an example of the second category, image retrieval. The image retrieval process illustrated in FIG. 1E may be performed in FIG. 1A. In the image retrieval technique, the global feature vector of the input image may be received at block 141. The global feature vector may be computed as described relative to blocks 110-130 in FIG. 1A. The image retrieval algorithm may be performed at block 142 by comparing the global feature vector of the input image to the feature vectors of the Large Feature Database 145. The Large Feature Database 145 may consist of global feature vectors of each of the images in a Large Image Search Database 143. The Large Image Search Database 143 may contain all the images searched during an image retrieval search. The compute feature vector for each image block 144 may compute a global feature vector for each image in the Large Image Search Database 143 in accordance with the techniques described relative to FIG. 1A. The Large Feature Database 145 results from these computations. The Large Feature Database 145 may be computed off-line prior to the image retrieval search.

The perform image retrieval algorithm at block 142 may perform the image retrieval algorithm based on the global image feature vector of the input image and the feature vectors in the Large Feature Database 145. For example, block 142 may calculate the Euclidean distance between the global image feature vector of the input image and each of the feature vector in the Large Feature Database 145. The result of the computation at block 142 may be outputted at Output Search Results block 146. If multiple results are returned, the results may be ranked and the ranking may be provided along with the results. The ranking may be based on the distance between the input global feature vector and the feature vectors of the resulting images (e.g., the rank may increase based on increasing distance).

Generally, in image search retrieval methods the search system may be given an image of a scene, and the system aims to find all images of the same scene, even images of the same scene that were altered due to a task-related transformation. Examples of such transformations include changes in scene illumination, image cropping, scaling, wide changes in the perspective of the camera, high compression ratios, or picture-of-video-screen artifacts.

FIG. 1F illustrates an example of the first category, semantic search. The semantic search process illustrated in FIG. 1F may be performed in FIG. 1A. In the semantic search technique the aim is to retrieve images containing visual concepts. For example, the search system may search images to locate images containing images of cats. During semantic search a set of positive and negative images may be provided at blocks 151 and 152, respectively. The images in the positive group may contain the visual concept that is being searched (e.g., cats), and the images in the negative group do not contain this visual concept (e.g., no cats, instead contain dogs, other animals or no animals). Each of these positive and negative images may be encoded at blocks 153, 154, respectively, resulting in global feature vectors for all the input positive and negative images. The global feature vectors from blocks 153 and 154 are then provided to a classifier learning algorithm 155. The classifier learning algorithm may be an SVM algorithm that produces a new vector in feature space. Other standard image classification methods can be used instead of the SVM algorithm. The inner product with this new vector may be used to compute a ranking of the image results. The resulting classifier from block 155 is then applied to all the feature vectors in a Large Feature Database 160 in order to rank these feature vectors by pertinence. The results of the application of the classifier may then be outputted at block 157.

The Large Feature Database 160 may consist of global feature vectors of each of the images in a Large Image Search Database 158. The Large Image Search Database 158 may contain of all the images searched during an image retrieval search. The compute feature vector for each image block 159 may compute a global feature vector for each image in the Large Image Search Database 160 in accordance with the techniques described relative to FIG. 1A. The Large Feature Database 160 results from these computations. The Large Feature Database 160 may be computed off-line prior to the image retrieval search.

The problem with the existing extraction of local image descriptors and encoding of such local descriptors is that each local descriptor is assigned to either one of a codeword from the K-means codebook (for the case of bag-of-words or VLAD) or to a GMM mixture components via soft-max weights (for the case of the Fisher encoder). This poses a problem because there are local descriptors that are too far away from all codewords or GMM mixture components for the assignment to be reliable. Despite this limitation, existing schemes must assign these too-faraway descriptors. The assignment of these too-faraway descriptors results in a degradation of the quality of the search based on such encodings. Therefore, there is a need to prune these too-faraway local descriptors in order to improve the quality of the resulting search results.

Avila et al., Pooling in image representation: the visual codeword point of view, 2013 and Avila et al., BOSSA: Extended Bow Formalism for Image Classification, 2011 discuss keeping a histogram of distances between local descriptors found in an image and the codewords of the codebook, however this does not cure the existing problems. First, the Avila methods do not relate to pruning local descriptors. Instead, the Avila methods relate to creating sub-bins per Voronoi cell by defining up to five distance thresholds from the cell's code word. Avila does not consider using Mahalanobis metrics to compute the distances. The Avila methods are also limited to bag-of-words aggregators. Moreover, the Avila methods do not consider soft weight extensions of local descriptor pruning.

Likewise, the following do not describe a model of distribution of local descriptors (e.g., a codebook or a GMM model) and do not describe pruning in the local descriptor space (e.g., per-cell basis or otherwise): U.S. Pat. No. 8,705,876; Zhiang Wu et al., A novel noise filter based on interesting pattern mining for bag-of-features images, 2013; Sambit Bakshi et al., Postmatch pruning of SIFT pairs for iris recognition; Saliency Based Space Variant Descriptor; Dounia Awad et al., Saliency Filtering of SIFT Detectors: Application to CBIR; Eleonara Vig et al., Space-variant Descriptor Sampling for Action Recognition Based on Saliency and Eye Movements.

### BRIEF SUMMARY OF PRESENT PRINCIPLES

There is a need for a mechanism that allows the pruning of local descriptors in order to improve searching performance.

An aspect of present principles is directed to methods, apparatus and systems for processing an image for image searching comprising. The apparatus or systems may include a memory, a processor, a local descriptor pruner configured to prune at least a local descriptor based on a relationship of the local descriptor and a codeword to which the local descriptor is assigned, wherein the local descriptor pruner assigns a weight value for the local descriptor based on the relationship of the local descriptor and the codeword and wherein the weight value is utilized by an image encoder during encoding. The method may include pruning a local descriptor based on a relationship of the local descriptor and a codeword to which the local descriptor is assigned; wherein pruning of the local descriptor includes assigning a weight value for the local descriptor based on the relationship of the local descriptor and the codeword and wherein the weight value is utilized during encoding of the pruned local descriptor.

An aspect of present principles is directed to, based on a determination by the local descriptor pruner, the local descriptor pruner assigns a hard weight value or a soft weight value that is either 1 or 0. In one example, the soft weight value is determined based on either exponential weighting or inverse weighting. The weight may be based on a distance between the local descriptor and the codeword. Alternatively, the weight based on the following equation wₖ(x)=[[(x−cₖ)^{T}Mₖ⁻¹(x−cₖ)≦γσₖ²]], wherein k is an index value, x is the local descriptor, cₖ is the assigned codeword, and γ, σₖ, and Mₖ are parameters computed prior to initialization, and [[ . . . ]] is the evaluation to 1 if the condition is true and 0 otherwise. Alternatively, the weight may based on a probability value determined based on a GMM model evaluated at the local descriptor. Alternatively, the weight may be based on a parameter that is computed from a training set of images. The image encoder may be at least one selected from the group of a Bag of Words encoder, a Fisher Encoder or a VLAD encoder. There may be further an image searcher configured to retrieve at least an image result based on the results of the image encoder. There may be further computed at least an image patch and configured to extract a local descriptor for the image patch.

### BRIEF SUMMARY OF THE DRAWINGS

The features and advantages of the present invention may be apparent from the detailed description below when taken in conjunction with the Figures described below:

FIG. 1A illustrates a flow diagram for a standard image processing pipeline for image searching.

FIG. 1B illustrates a flow diagram for performing local descriptor detection using the patches in FIG. 1C or ID.

FIG. 1C illustrates a diagram showing an example of image patches identified using a dense detector.

FIG. 1D illustrates a diagram showing an example of image patches identified using a sparse detector.

FIG. 1E illustrates a flow diagram showing an example of an image retrieval search.

FIG. 1F illustrates a flow diagram showing an example of a semantic search.

FIG. 2 illustrates a flow diagram for an exemplary method for performing image processing with local descriptor pruning in accordance with an example of the present invention.

FIG. 2A illustrates a flow diagram for an exemplary method for performing local descriptor pruning in accordance with an example of the present invention.

FIG. 2B illustrates an example of a visual representation of a result of an exemplary pruning process.

FIG. 3 illustrates a block diagram of an exemplary image processing device.

FIG. 4 illustrates a block diagram of an exemplary distributed image processing system.

FIG. 5 illustrates an exemplary plot of percentage of Hessian-Affine SIFT descriptors that are pruned versus threshold values in accordance with an example of the present invention.

FIG. 6 illustrates an exemplary plot for selection of a pruning parameter when performing hard pruning of local descriptors in accordance with an example of the present invention.

FIG. 7 illustrates an exemplary plot for selection of a pruning parameter when performing soft pruning in accordance with an example of the present invention.

### DETAILED DESCRIPTION

Examples of the present invention relate to an image processing system that includes a local descriptor pruner for pruning the local descriptors based on a relationship between the local descriptor and a codeword to which the local descriptor is assigned. The local descriptor assigns a weight value for the local descriptor based on the relationship of the local descriptor and the codeword and this weight value is then utilized during encoding.

Examples of the present invention also relate to a method for pruning local descriptors based on a relationship between the local descriptor and a codeword. The method assigns a weight value for the local descriptor based on the relationship of the local descriptor and the codeword and the weight value is utilized by an image encoder during encoding.

In one example, the local descriptor pruner or the pruning method can assign a hard weight value that is either 1 or 0. In one example, the local descriptor pruner or the pruning method can assign a soft weight value that is between 0 and 1. In one example, the local descriptor pruner or the pruning method can determine the soft weight value based on either exponential weighting or inverse weighting. In one example, the local descriptor pruner or the pruning method can determine the weight based on a distance between the local descriptor and the codebook cell. In one example, the local descriptor pruner or the pruning method can determine the weight based on the following equation wₖ(x)=[[(x−cₖ)^{T}Mₖ⁻¹(x−cₖ)≦γσₖ²]], where k is an index value, x is the local descriptor, cₖ is the assigned codeword, and γ, σₖ, and Mₖ are parameters computed prior to initialization, and [[ . . . ]] is the evaluation to 1 if the condition is true and 0 otherwise. In one example, the local descriptor pruner or the pruning method can determine the weight based on a probability value determined based on a GMM model evaluated at the local descriptor. In one example, the local descriptor pruner or the pruning method can determine the weight based on a parameter that is computed from a training set of images.

In one example, the image encoder is at least one of a Bag of Words encoder, a Fisher Encoder or a VLAD encoder. The encoding of the method can be based on at least one of a Bag of Words encoder, a Fisher Encoder or a VLAD encoder.

In one example, the system or method further comprise an image searcher or an image searching method for retrieving an image based on the results of the image encoder or image encoding, respectively.

In one example, the system or method further comprise a local descriptor extractor or a local descriptor extracting method for computing at least an image patch and configured to extract a local descriptor for the image patch.

The scalars, vectors and matrices notation may be denoted by respectively standard, underlined, and underlined uppercase typeface (e.g., scalar a, vector a and matrix A). A variable vₖ may be used to denote a vector from a sequence v₁, v₂, . . . , v_{N}, and vₖ to denote the k-th coefficient of vector v. The following notation [aₖ]ₖ (respectively, [aₖ]ₖ) denotes concatenation of the vectors aₖ (scalars aₖ) to form a single column vector. The following notation ,[[.]] denotes the evaluation to 1 if the condition is true and 0 otherwise.

The present invention may be implemented on any electronic device or combination of electronic devices. For example, the present invention may be implemented on any of variety of devices including a computer, a laptop, a smartphone, a handheld computing system, a remote server, or on any other type of dedicated hardware. Various examples of the present invention are described below with reference to the figures.

Exemplary Process of Image Searching with Local Descriptor Pruning

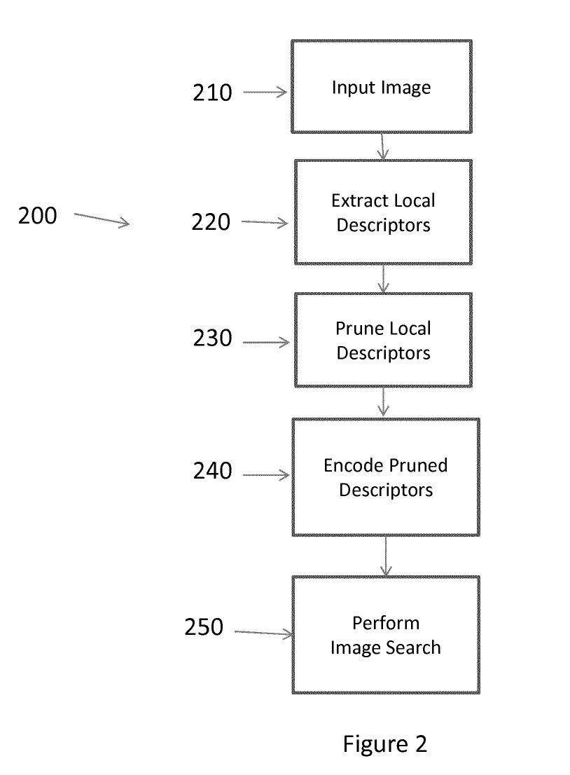

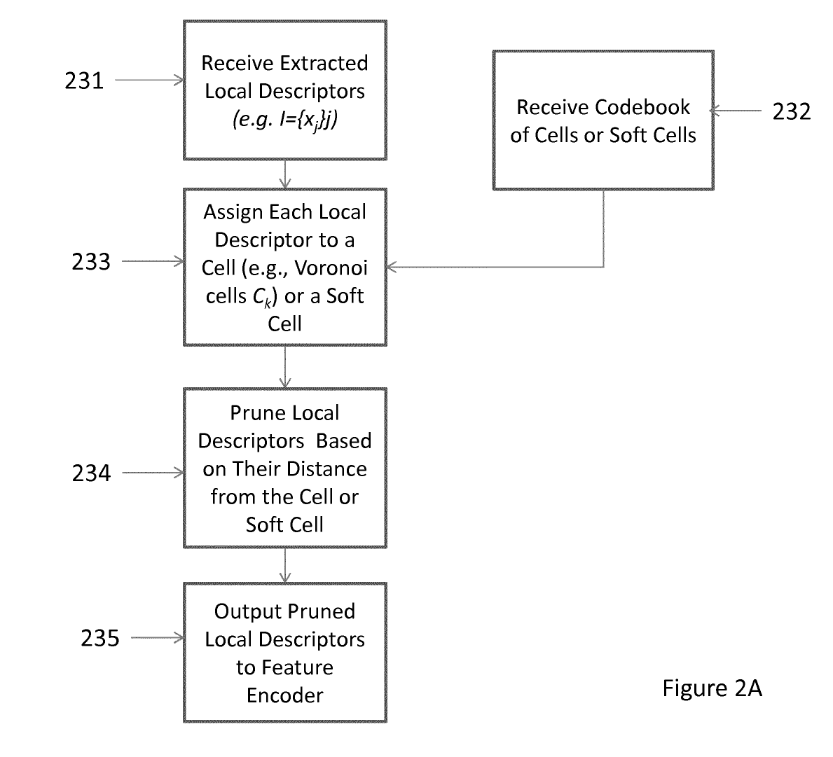

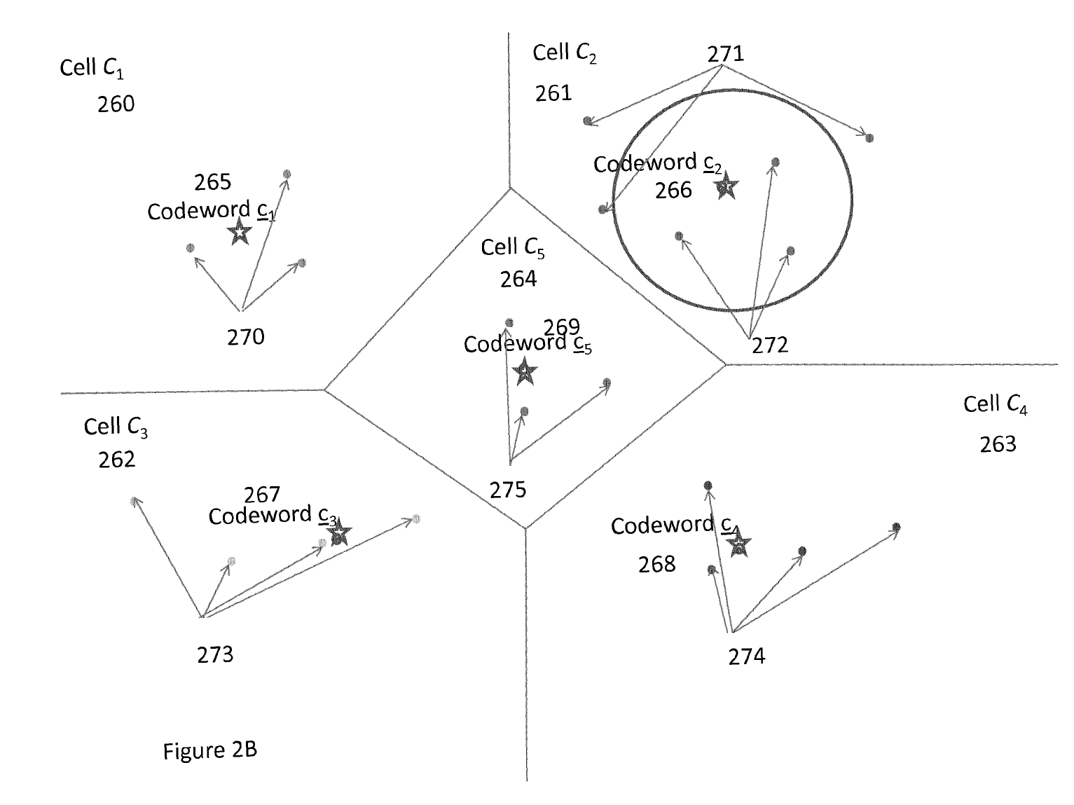

FIG. 2 is a flow diagram illustrating an exemplary method 200 for performing image processing with local descriptor pruning in accordance with an example of the present disclosure. The image processing method 200 includes Input Image block 210. Input Image block 210 receives an inputted image. In one example, the inputted image may be received after a selection by a user. Alternatively, the inputted image may be captured or uploaded by the user. Alternatively, the inputted image may be received or generated by a device such as a camera and/or an image processing computing device.

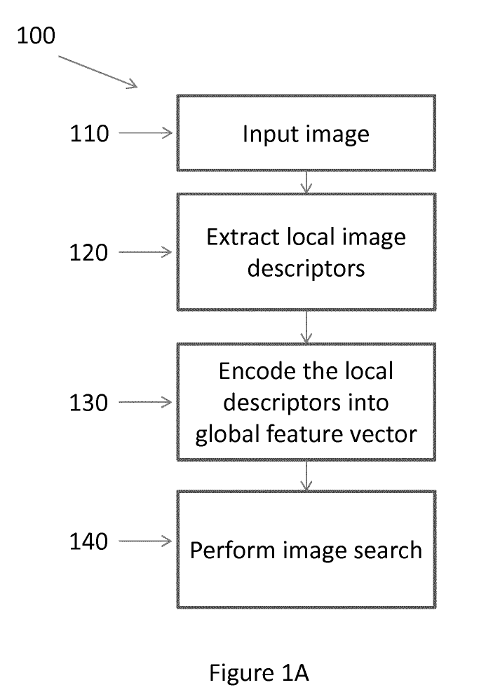

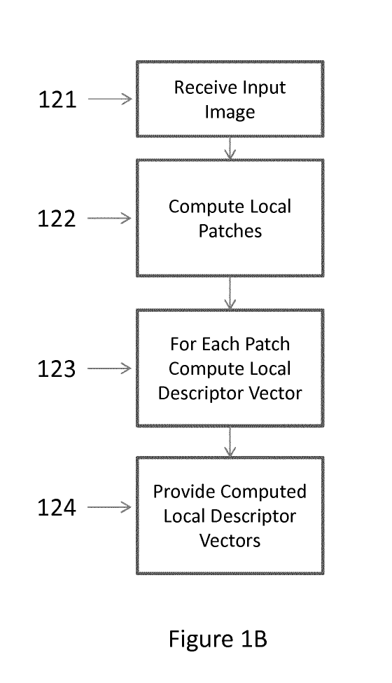

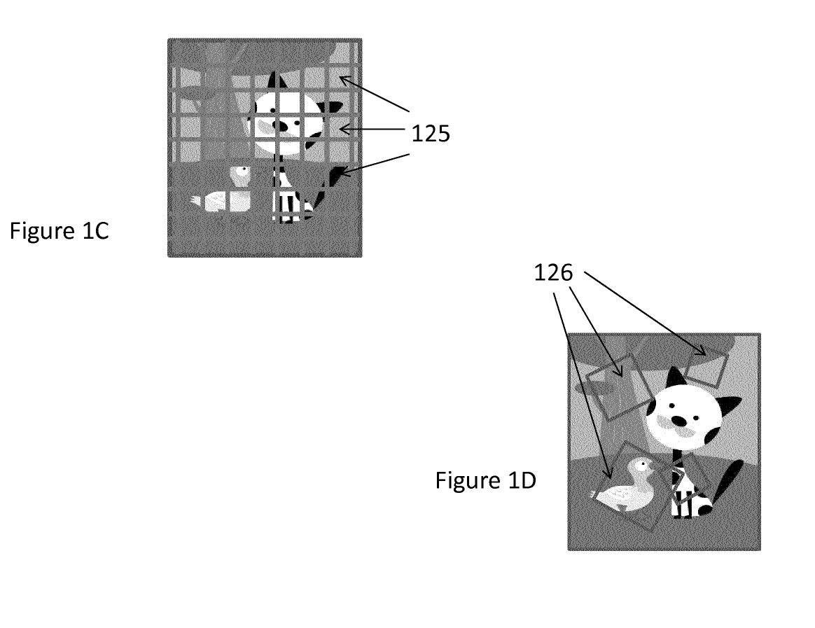

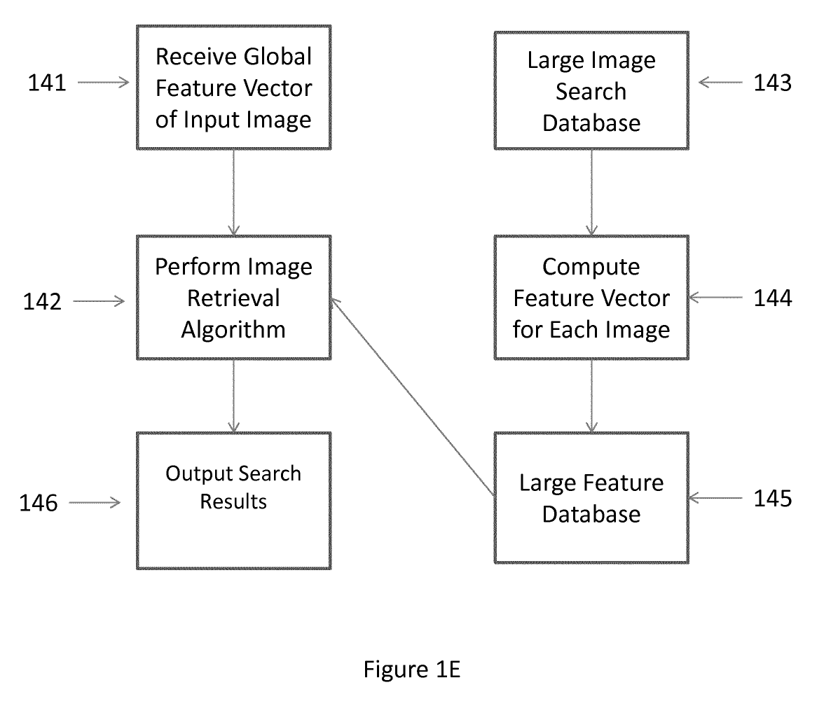

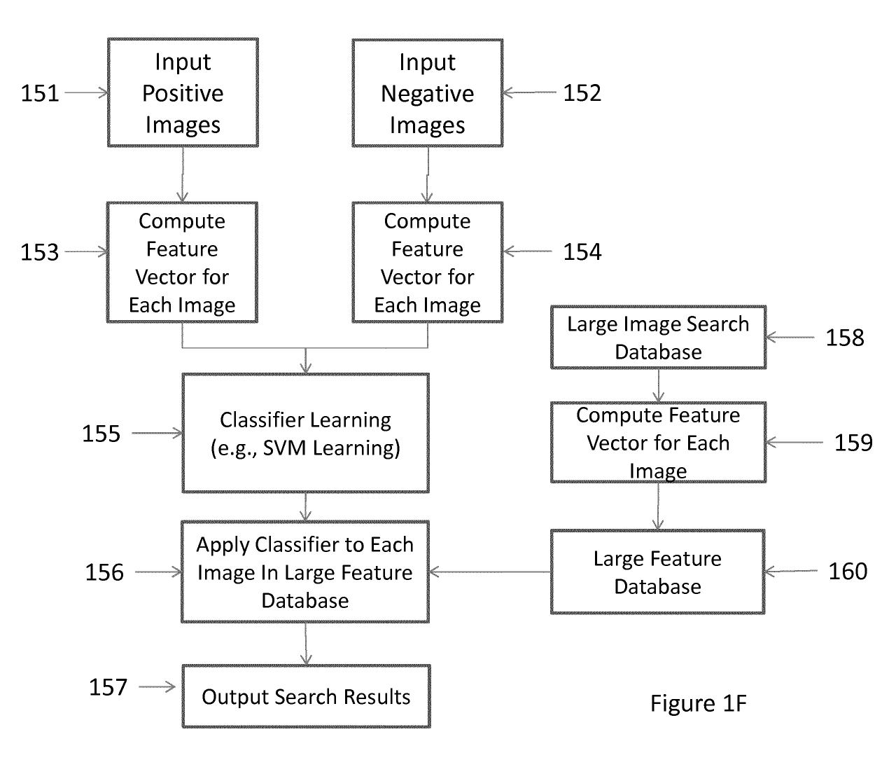

The Extract Local Descriptors block 220 may receive the input image from Input Image block 210. The Extract Local Descriptors block 220 may extract local descriptors in accordance with the processes described in connection with FIGS. 1A-1D.

The Extract Local Descriptors block 220 may compute one or more patches for the input image. In one example, the image patches may be computed using a dense detector, an example of which is shown in FIG. 1C. In another example, the image patches may be computed using a sparse detector, an example of which is shown in FIG. 1D.

For each image patch, the Extract Local Descriptors block 220 extracts a local descriptor using a local descriptor extraction algorithm. For example, the Extract Local Descriptors block 220 may extract local descriptors in accordance with the processes described in connection with FIGS. 1A-1B.

In one example, the Extract Local Descriptors block 220 extracts the local descriptors for each image patch by using a Scale Invariant Feature Transform (SIFT) algorithm on each image patch resulting in a corresponding SIFT vector for each patch. The SIFT vector may be of any number of entries. In one example, the SIFT vector may have 128 entries. In one example, the Extract Local Descriptors block 220 may compute N image patches for an image (image patch i, where i=1, 2, 3 . . . N). For each image patch i, a SIFT vector of size 128 is computed. At the end of processing, the Extract Local Descriptors block 220 outputs N SIFT local descriptor vectors, each SIFT local descriptor vector of size 128. In another example, the Extract Local Descriptors block 220 may use an algorithm other than the SIFT algorithm, such as, for example: Speeded Up Robust Features (SURF), Gradient Location and Orientation Histogram (GLOH), Local Energy based Shape Histogram (LESH), Compressed Histogram of Gradients (CHoG); Binary Robust Independent Elementary Features (BRIEF), Discriminative Binary Robust Independent Elementary Features (D-BRIEF) or the Daisy descriptor.

The output of the Extract Local Descriptors block 220 may be a set of local descriptors vectors. In one example, the output of Extract Local Descriptors block 220 may be a set I={xᵢεR^{d}}ᵢ of local SIFT descriptor vectors, where each xᵢ represents a local descriptor vector computed for a patch of the inputted image.

The Prune Local Descriptors block 230 receives the local descriptors from the Extract Local Descriptors block 220. The Prune Local Descriptors block 230 prunes the received local descriptors to remove local descriptors that are too far away from either codewords or GMM mixture components of an encoder. The pruning of such too-far away local descriptors prevents the degradation in quality of image searching. The present invention thus allows the return of more reliable image search results by pruning local descriptors that are too far away to be visually informative. This is particularly beneficial in multi-dimensional descriptor spaces, and particularly in high-dimensional local descriptor spaces, because in those spaces cells are almost always unbounded, meaning that they have infinite volume. Yet only a part of this volume is informative visually. The present invention allows the system to isolate this visually informative information by pruning non-visually informative local descriptors.

The Prune Local Descriptors block 230 may employ a local-descriptor pruning method applicable to any subsequently used encoding methods (BOW, VLAD and Fisher). In one example, the Prune Local Descriptors block 230 may receive a signal indicating the encoder that is utilized. Alternatively, the Prune Local Descriptors block 230 may prune the local descriptors vectors independent of the subsequent encoding method. Generally, the Prune Local Descriptors block 230 may prune local descriptors vectors for any feature encoding methods based on local descriptors where each local descriptor is related to a cell Cₖ or mixture component/soft cell (βₖ,cₖ,Σₖ), where k denotes the index. In one example, cell Cₖ denotes a Voronoi cell {x|xεR^{d},k=argminⱼ|x−cⱼ|} associated to codeword cₖ. In another example, βᵢ,cᵢ, Σᵢ denotes the soft cell of the i-th GMM component, where βᵢ=prior weight i; cᵢ=mean vector i; Σᵢ=covariance matrix i (assumed diagonal).

In one example, a cell Cₖ may denote a Voronoi cell {x|xεR^{d},k=argminⱼ|x−cⱼ|} associated with a codeword cₖ. The codewords cₖ may be learned using a set of training SIFT (or any other type of local descriptor) vectors from a set of training images and are kept fixed during encoding. The learning of the codewords cₖ may be performed at an initialization stage using K-means, where, for example, a vector may be computed to be the average of all the SIFT vectors assigned to cell number k. For example, for a codeword c₁, each SIFT vector xᵢ (i=1, 2, 3, 4, . . . ) that is closer to c₁ than to any other cₖ, where k is a number other than 1, is assigned to cell number 1. Once all the cₖ are computed, the process is repeated until convergence, since changing the cₖ changes which SIFT vectors are closest to which cₖ.

In one example, each soft cell Cᵢ is defined by the parameters βᵢ=prior weight i; cᵢ=mean vector i; Σᵢ=covariance matrix i. These parameters for all the cells i=1, 2, 3, . . . , L are the output of a GMM learning algorithm implemented, for example, using standard approaches like the Expectation Maximization algorithm. When pruning descriptors based on GMM models, the same approach used for hard cells can be used: soft and hard weights wᵢ(x) can be computed based on the distance between x and cᵢ. An alternate hard pruning approach tailored to GMM models is to apply a threshold (learned experimentally so as to maximize the mAP on a training set) on the probability value p(x) produced by the GMM model at the point x. A soft-pruning approach might instead use the probability itself or a mapping of this probability. A possible mapping is p(x)^{a} for some value of a between 0 and 1.

In one example, the Prune Local Descriptors block 230 prunes the local descriptors of the inputted image based on a determination of whether the local descriptors are too far away from their assigned cells or soft cells. For example, the block 230 determines whether the local descriptors are too far from the codeword of cell Cₖ or a mixture component (βₖ,cₖ,Σₖ) (soft cells). In one example, the Prune Local Descriptors block 230 may prune the local descriptors by removing the local descriptors that exceed a threshold distance between the local descriptor and the codeword cₖ at the center of the cell Cₖ containing the local descriptor.

FIG. 2A illustrates a process for pruning local descriptors in accordance with an example of the present invention. The process shown in FIG. 2A may be implemented by Prune Local Descriptors block 230 is shown in FIG. 2. In one example, the pruning process receives the unpruned local descriptors at block 231.

In one example, the pruning process may receive a codebook including codewords relating to cells or soft cells at block 232. The codebook may either be received from local storage or through a communication link with a remote location. The codebook may be initialized at or before the initialization of the pruning process. In one example, a codebook {cₖ}ₖ defines Voronoi cells {Cₖ}ₖ where k denotes the index of the cell. In another example, a codebook may include soft cells Cᵢ defined by the parameters βᵢ=prior weight i; cᵢ=mean vector i; Σᵢ=covariance matrix i.

In one example, the pruning process assigns at block 233 each local descriptor to a cell or a soft cell received at block 232. In one example, the pruning process may assign each local descriptor to a cell by locating the cell whose codeword has the closest Euclidean distance to the local descriptor.

In one example the assigned local descriptors are pruned at block 234. In one example, the pruning process at block 234 evaluates each local descriptor to determine whether that local descriptor is too far away from its assigned cell or soft cell. In one example, the pruning process determines whether the local descriptor is too far away based on a determination if the distance between that local descriptor and the center or codeword of its assigned cell or soft cell exceeds a calculated or predetermined threshold. In an illustrative example, if a local descriptor is assigned to cell no. 5, the pruning process 234 may test whether the Euclidean distance between that local descriptor vector and the codeword vector no. 5 does not exceed a threshold. In another example, the pruning process may determine a probability value for the local descriptor relative to a cell(s) or a soft cell(s). The pruning process may determine if the probability value is below or above a certain threshold and prune local descriptors based on this determination. In an illustrative example, a GMM model may yield a probability value for a local descriptor x, where the probability value is between 0 and 1. In one example, the pruning process may prune the local descriptor x if the probability value is lower than a certain threshold. (e.g., less than thresh=0.01). The value of this threshold can be determined experimentally using a training set.

In one example, each local descriptor may be pruned by assigning a hard weight value (1 or 0) based on whether the local descriptor exceeds a threshold distance between the local descriptor and its assigned cell or soft cell. Alternatively, the local descriptors may be pruned by assigning a soft weight value (between 0 and 1) to each local descriptor based on the distance between the local descriptor and its assigned cell or soft cell.

In one example, each local descriptor x may be pruned based on whether the distance between local descriptor x and its assigned codeword cₖ exceeds the threshold determined by the following distance-to-cₖ condition:

(x−cₖ)^{T}Mₖ⁻¹(x−cₖ)≦γσₖ². (Equation 1)

The parameters γ, σₖ, and Mₖ may be computed prior to initialization and may be either stored locally or received via a communication link.

In one example, the value of γ is determined experimentally by cross-validation and the parameter σₖ is computed from the variance of a training set of local descriptors [symbol] as follows:

σₖ= [symbol] ((x−cₖ)^{T}Mₖ⁻¹(x−cₖ)) (Equation 2)

In one example, the matrix Mₖ can be any of the following

Anisotropic Mₖ: the empirical covariance matrix computed from [symbol] ∩Cₖ;

Axis-aligned Mₖ: the same as the anisotropic Mₖ, but with all elements outside the diagonal set to zero;

Isotropic Mₖ: a diagonal matrix σₖ²I with σₖ² equal to the mean diagonal value of the axis-aligned Mₖ.

While the anisotropic variant may offer the most geometrical modelling flexibility, it may also increase computational cost. The isotropic variant, on the other hand, enjoys practically null computational overhead, but may have the least modelling flexibility. The axis-aligned variant offers a compromise between the two approaches.

### Hard Weights

In one example, the pruning of local descriptors can be implemented by Equation 1 by means of 1/0 weights as follows, where [[.]] is the indicator function that evaluates to one if the condition is true and zero otherwise,

wₖ(x)=[[(x−cₖ)^{T}Mₖ⁻¹(x−cₖ)≦γσₖ²]] (Equation 3)

### Soft Weights

In another example, the pruning of local descriptors can be implemented by Equation 1 using soft weights.

In another example, the soft-weights may be computed using exponential weighting, where

$${w}_{k} ( \underline{x} ) = exp ( - {}_{{σ}_{k}}^{\frac{ω}{2}}{( \underline{x} - {\underline{c}}_{k} )}{}_{}^{T} {\underline{M}}_{k}^{- 1} ( \underline{x} - {\underline{c}}_{k} ) ) . \qquad ( Equation 4 )$$

In another example, the soft-weights may be computed using inverse weighting, where

$${w}_{k} ( \underline{x} ) = \frac{{σ}_{k}^{2}}{{( \underline{x} - {\underline{c}}_{k} )}^{T} {\underline{M}}_{k}^{- 1} ( \underline{x} - {\underline{c}}_{k} )} . \qquad ( Equation 5 )$$

In one example, the pruned local descriptors are outputted at block 235.

FIG. 2B illustrates an example of a visual representation of a result of an exemplary pruning process. FIG. 2B illustrates five cells, 260-264 (Cells C₁-C₅). Each cell has a corresponding codeword. Cell C₁ 260 corresponds with codeword c₁ 265. Cell C₂ 261 corresponds with codeword c₂ 266. Cell C₃ 262 corresponds with codeword c₃ 267. Cell C₄ 263 corresponds with codeword c₄ 268. Cell C₅ 264 corresponds with codeword c₅ 269. In each cell, local descriptors x have been assigned. The local descriptors are shown by dots in FIG. 2B. For example, local descriptors 270 have been assigned to Cell C₁ 260. Local descriptors 271 and 272 have been assigned to Cell C₂ 261. Local descriptors 273 have been assigned to Cell C₃ 262. Local descriptors 274 have been assigned to Cell C₄ 263. Local descriptors 275 have been assigned to Cell C₅ 264.

FIG. 2B also illustrates the outcome of pruning the local descriptors in Cell C₂. 261. The local descriptors 272 within the ellipse have been found to be within the threshold distance and thus are not pruned. The local descriptors 271 outside the ellipse are outside the threshold distance and thus are pruned. In one example, the local descriptors 272 have been assigned weight w(x)=1 and the local descriptors 271 have been assigned a weight w(x)=0.

The Encode Pruned Descriptors block 240 may receive the pruned local descriptors from the Prune Local Descriptors 230. The Encode Pruned Descriptors block 240 may compute image feature vectors by encoding the pruned local descriptors received from the Prune Local Descriptors block 230. The Encode Pruned Descriptors block 240 may use an algorithm such as a Bag-of-Words (BOW), Fisher or VLAD algorithm, or any other algorithm based on a codebook obtained from any clustering algorithm such as K-means or from a GMM model. The Encode Pruned Descriptors block 240 may encode the pruned local descriptors in accordance with the process described in FIG. 1A.

In one example, the Encode Pruned Descriptors block 240 may utilize a bag-of-words (BOW) encoder. The BOW encoder may be based on a codebook {cₖΣR^{d}}ₖ₌₁^{L} obtained by applying K-means to all the local descriptors [symbol] =UₜIₜ of a set of training images. Letting Cₖ denote the Voronoi cell {x|xεR^{d},k=argminⱼ|x−cⱼ|} associated to codeword cₖ, the resulting feature vector for image I may be

$$\begin{matrix}{\underline{r}}^{B} = {[ {r}_{k}^{B} ]}_{k} , where & ( Equation 6 ) \\ {r}_{k}^{B} = {\sum }_{\underline{x} ∈ I ⋂ {C}_{k}} {w}_{k} ( \underline{x} ) \frac{[ [ \underline{x} ∈ {C}_{k} ] ]}{{\sum }_{k , \underline{x} ∈ I} {w}_{k} ( \underline{x} )} . & ( Equation 7 )\end{matrix}$$

where [[.]] is the indicator function that evaluates to 1 if the condition is true and 0 otherwise and where [aₖ]ₖ denotes concatenation of the vectors aₖ (scalars aₖ) to form a single column vector.

In another example, the Encode Pruned Descriptors block 240 may utilize a Fisher encoder that may rely on a GMM model also trained on [symbol] . Letting βᵢ,cᵢ, Σᵢ denote, respectively, the i-th GMM component's 1. prior weight, 2. mean vector, and 3. covariance matrix (assumed diagonal), the first-order Fisher feature vector may be

$$\begin{matrix}{\underline{r}}^{F} = {[ {\underline{r}}_{k}^{F} ]}_{k} , where & ( Equation 8 ) \\ {\underline{r}}_{k}^{F} = {\sum }_{\underline{x} ∈ I} \frac{p ( k \vert \underline{x} )}{\sqrt{{β}_{i}}} {\underline{\sum }}_{k}^{- 1} {w}_{k} ( \underline{x} ) ( \underline{x} - {\underline{c}}_{k} ) . & ( Equation 9 )\end{matrix}$$

In another example, the Encode Pruned Descriptors block 240 may use a hybrid combination between BOW and Fisher techniques called VLAD. The VLAD encoder which may offer a compromise between the Fisher encoder's performance and the BOW encoder's processing complexity. The VLAD encoder may, similarly to the state-of-the art Fisher aggregator, encode residuals x−cₖ, but may also hard-assign each local descriptor to a single cell Cₖ instead of using a costly soft-max assignment as in Equation (9). The resulting VLAD encoding may be

$$\begin{matrix}{\underline{r}}^{V} = {[ {\underline{r}}_{k}^{V} ]}_{k} , where & ( Equation 10 ) \\ {\underline{r}}_{k}^{V} = {\underline{Φ}}_{k}^{T} {\sum }_{\underline{x} ∈ I ⋂ {C}_{k}} {w}_{k} ( \underline{x} ) \frac{\underline{x} - {\underline{c}}_{k}}{\vert \underline{x} - {\underline{c}}_{k} \vert} ∈ {R}^{d} , & ( Equation 11 )\end{matrix}$$

where Φₖ are orthogonal PCA rotation matrices obtained from the training descriptors Cₖ∩ [symbol] in the Voronoi cell. After computing the sub-vectors rₖ^{B}, rₖ^{F}, or rₖ^{V}, these are stacked as in Equations (6), (8) and (10) to obtain a single large vector r^{B}, r^{F} or r^{V} (we use r to denote any of these variants). Two normalization steps are applied as per the standard approach in the literature: a power-normalization step, were each entry rᵢ of r is substituted by sign(rᵢ) abs(rᵢ)^{a}. (common values of a are 0.2 or 0.5) and an 1-2 normalization step were every entry of the power-normalized vector is divided by the Euclidean norm of the power normalized-vector.

The Search Encoded Images block 250 receives the feature vector(s) computed by Encode Pruned Descriptors block 240. The Search Images block 250 may perform a search for one or more images by comparing the feature vector(s) received from Encoded Pruned Descriptors block 240 and the feature vectors of a search images database. The Search Images block 250 may perform an image search in accordance with the processes described in FIGS. 1A, 1E, and 1F.

Exemplary Image Processing System

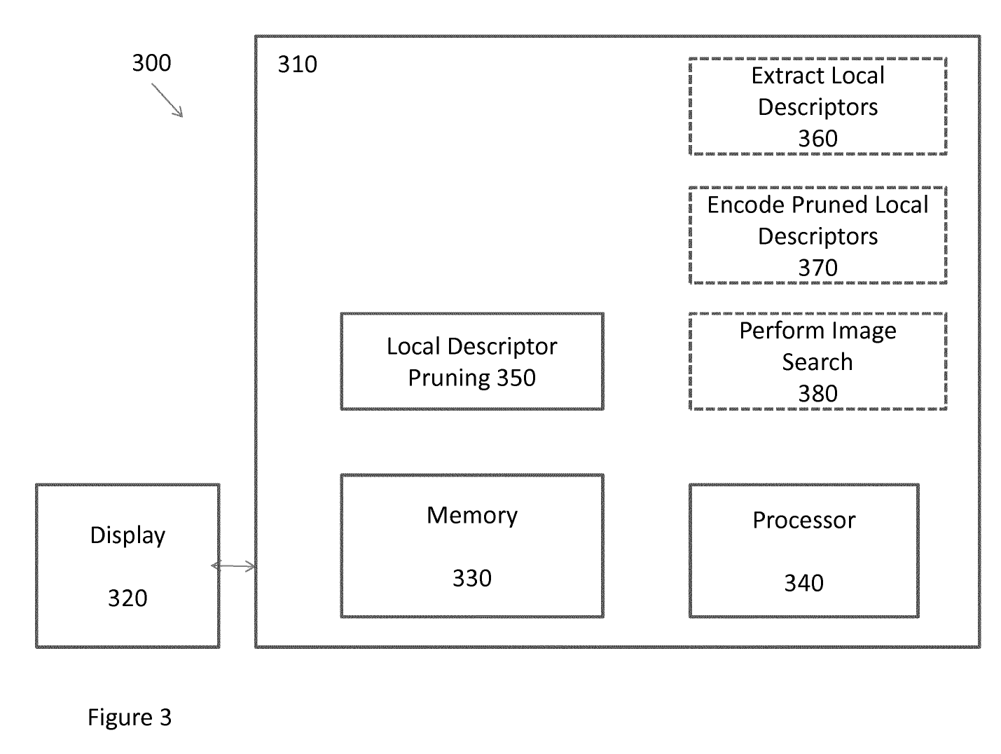

FIG. 3 is a block diagram illustrating an exemplary image processing system 300. The image processing system includes an image processing device 310 and a display 320. In one example, the device 310 and the display 320 may be connected by a physical link. In another example, the device 310 and the display 320 may communicate via a communication link, such as, for example a wireless network, a wired network, a short range communication network or a combination of different communication networks.

The display 320 may allow the user to interact with image processing device 310, including, for example, inputting criteria for performing an image search. The display 320 may also display the output of an image search.

The image processing device 310 includes memory 330 and processor 340 that allow the performance of local descriptor pruning 350. The image processing device 310 further includes any other software or hardware necessary to perform local descriptor pruning 350.

The image processing device 310 executes the local descriptor pruning 350 processing. In one example, the image processing device 310 performs the local descriptor pruning 350 based on an initialization of an image search process by a user either locally or remotely. The local descriptor pruning 350 executes the pruning of local descriptors in accordance with the processes described in FIGS. 2, 2A and 2B.

In one example, the image processing device 310 may store all the information necessary to perform the local descriptor pruning 350. For example, the image processing device 310 may store and execute the algorithms and database information necessary to execute the local descriptor pruning 350 processing. Alternatively, the image processing system 310 may receive via a communication link one or more of the algorithms and database information to execute the local descriptor pruning 350 processing.

Each of the processing of extract local descriptors 360, encode pruned local descriptors 370, and perform image search 380 may be executed in whole or in part on image processing device 310. Alternatively, each of the extract local descriptors 360, encode pruned local descriptors 370, and perform image search 380 may be executed remotely and their respective results may be communicated to image processing device 310 via a communication link. In one example, the image processing device may receive an input image and execute extract local descriptors 360 and prune local descriptors 350. The results of prune local descriptors 350 may be transmitted via a communication link. The encode pruned local descriptors 370 and perform image search 380 may be executed remotely, and the results of perform image search 380 may be transmitted to image processing device 310 for display on display 320. The dashed boxes of extract local descriptors 360, encode pruned local descriptors 370, and perform image search 380 thus indicate that these processes may be executed on image processing device 310 or may be executed remotely. The extract local descriptors 360, encode pruned local descriptors 370, and perform image search 380 processes may be executed in accordance with the processes described in relation to FIGS. 1A-1F and FIG. 2.

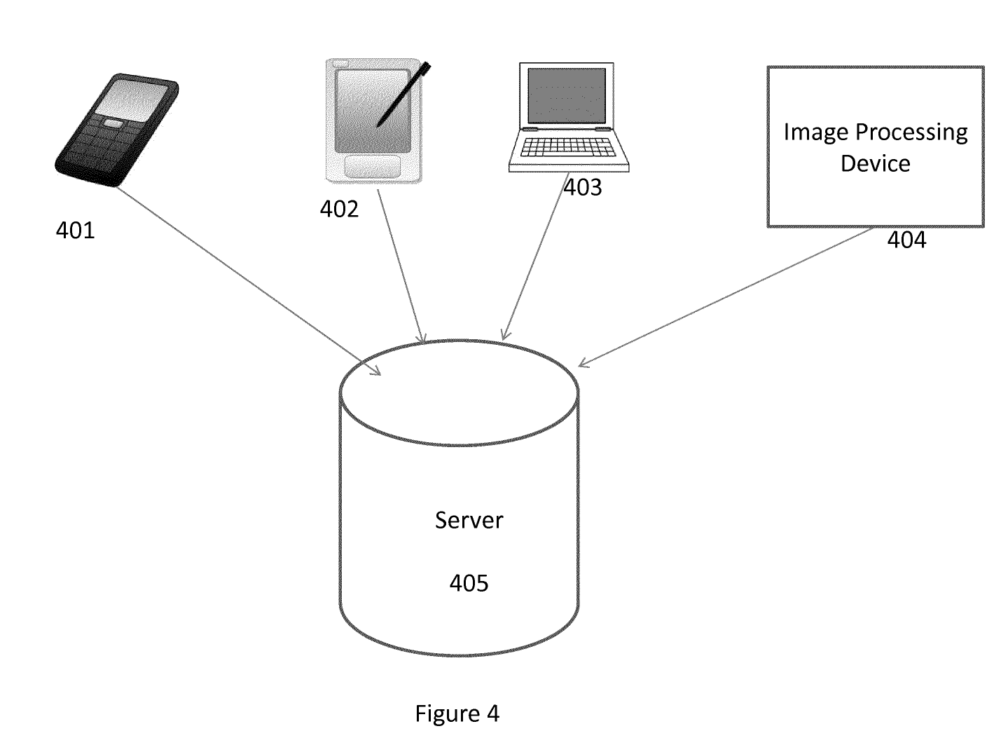

FIG. 4 illustrates an example of various image processing devices 401-404 and a server 405. The image processing devices may be smartphones (e.g., device 401), tablets (e.g., device 402), laptops (e.g., device 403), or any other image processing device that includes software and hardware to execute the features of the present invention. The image processing devices 401-404 may be similar to the image processing device 310 and the image processing system 300 described in connection with FIG. 3. The local descriptor pruning processes described in accordance with FIGS. 2, 2A and 2B may be executed on any of the devices 401-404, on server 405, or in a combination of any of the devices 401-404 and server 405.

### Exemplary Local Descriptor Pruning

In one example, image encoders operate on the local descriptors xεR^{d} extracted from each image. Images may be represented as a set I={xᵢεR^{d}}ᵢ of local SIFT descriptors extracted densely or with a Hessian Affine region detector.

In one example, local descriptors may be encoded using a BOW encoder. The BOW encoder may be based on a codebook {cₖεR^{d}}ₖ₌₁^{L} obtained by applying K-means to all the local descriptors [symbol] =UₜIₜ of a set of training images. Letting Cₖ denote the Voronoi cell {x|xεR^{d},k=argminⱼ|x−cⱼ|} associated to codeword cₖ, the resulting feature vector for image I may be

$$\begin{matrix}{\underline{r}}^{B} = {[ {r}_{k}^{B} ]}_{k} , where & ( Equation 12 ) \\ {r}_{k}^{B} = {\sum }_{\underline{x} ∈ I ⋂ {C}_{k}} \frac{[ [ \underline{x} ∈ {C}_{k} ] ]}{\# I} & ( Equation 13 )\end{matrix}$$

where [[.]] is the indicator function that evaluates to 1 if the condition is true and 0 otherwise.

In another example, local descriptors may be encoded using a Fisher encoder. The Fisher encoder relies on a GMM model also trained on [symbol] . Letting βᵢ,cᵢ, Σᵢ denote, respectively, the i-th GMM component's 1. prior weight, 2. mean vector, and 3. covariance matrix (assumed diagonal), the first-order Fisher feature vector may be

$$\begin{matrix}{\underline{r}}^{F} = {[ {\underline{r}}_{k}^{F} ]}_{k} , where & ( Equation 14 ) \\ {\underline{r}}_{k}^{F} = {\sum }_{\underline{x} ∈ I} \frac{p ( k \vert \underline{x} )}{\sqrt{{β}_{i}}} {\underline{\sum }}_{k}^{- 1} ( \underline{x} - {\underline{c}}_{k} ) . & ( Equation 15 )\end{matrix}$$

In another example, local descriptors may be encoded using a hybrid combination between BOW and Fisher techniques called VLAD which may offer a compromise between the Fisher encoder's performance and the BOW encoder's processing complexity. This hybrid encoder, similarly to the state-of-the art Fisher aggregator, may encode residuals x−cₖ, but may also hard-assign each local descriptor to a single cell Cₖ instead of using a costly soft-max assignment as in Equation 15. The resulting VLAD encoding may be

$$\begin{matrix}{\underline{r}}^{V} = {[ {\underline{r}}_{k}^{V} ]}_{k} , where & ( Equation 16 ) \\ {\underline{r}}_{k}^{V} = {\underline{Φ}}^{kT} {\sum }_{\underline{x} ∈ I ⋂ {C}_{k}} \frac{\underline{x} - {\underline{c}}_{k}}{\vert \underline{x} - {\underline{c}}_{k} \vert} ∈ {R}^{d} , & ( Equation 17 )\end{matrix}$$

where Φₖ are orthogonal PCA rotation matrices obtained from the training descriptors Cₖ∩ [symbol] in the Voronoi cell.

In one example, the following power-normalization and l₂ normalization post-processing stages may be applied to any of the feature vectors r in Equations (12), (14) and (16):

p=[hₐ(rⱼ)]ⱼ, (Equation 18)

n=g(p). (Equation 19)

Here the scalar function hₐ(x) and the vector function n(v) carry out power normalization and l₂ normalization, respectively:

$$\begin{matrix}h ( x ) = sign ( x ) {\vert x \vert}^{α} & ( Equation 20 ) \\ \underline{g} ( \underline{x} ) = \frac{\underline{x}}{{\vert \underline{x} \vert}_{2}} & ( Equation 21 )\end{matrix}$$

### Exemplary Local-Descriptor Pruning Method

In one example, the present invention employs a local-descriptor pruning method applicable to all three feature encoding methods described above (BOW, VLAD and Fisher), and in general to feature encoding methods based on stacking sub-vectors rₖ, where each sub-vector is related to a cell Cₖ or mixture component (βₖ,cₖ,Σₖ) (these can be thought as soft cells).

Unlike the case for low-dimensional sub-spaces, the cells Cₖ in high-dimensional local-descriptors spaces are almost always unbounded, meaning that they have infinite volume. Yet only a part of this volume is informative visually.

In one example, the visually informative information is pruned by removing the local descriptors that are too far away from the cell center cₖ when constructing the sub-vectors rₖ in Equations (13), (15) and (17). In one example, the pruning is performed by restricting the summations in Equations (13), (15) and (17) only to those vectors x that are in the cell Cₖ and satisfy the following distance-to-cₖ condition:

(x−cₖ)^{T}Mₖ⁻¹(x−cₖ)≦γσₖ². (Equation 22)

The value of γ is determined experimentally by cross-validation and the parameter σₖ is computed from a training set of local descriptors [symbol] as follows:

σₖ= [symbol] ((x−cₖ)^{T}Mₖ⁻¹(x−cₖ)) (Equation 23)

The matrix Mₖ can be either

Anisotropic Mₖ: the empirical covariance matrix computed from [symbol] ∩Cₖ;

Axis-aligned Mₖ: the same as the anisotropic Mₖ, but with all elements outside the diagonal set to zero;

Isotropic Mₖ: a diagonal matrix σₖ²I with σₖ² equal to the mean diagonal value of the axis-aligned Mₖ.

While the anisotropic variant offers the most geometrical modelling flexibility, it also drastically increases the computational cost. The isotropic variant, on the other hand, enjoys practically null computational overhead, but also the least modelling flexibility. The axis-aligned variant offers a compromise between the two approaches.

### Hard Weights

In one example, the pruning carried out by Equation 22 can be implemented by means of 1/0 weights

wₖ(x)=[[(x−cₖ)^{T}Mₖ⁻¹(x−cₖ)≦γσₖ²]] (Equation 24)

The weighs w(x) can be applied to the summation terms in Equations (13), (15) and (17). For example, for Equation 13 the weights would be used as follows:

$${r}_{k}^{B} = {\sum }_{\underline{x} ∈ I ⋂ {C}_{k}} {w}_{k} ( \underline{x} ) \frac{[ [ \underline{x} ∈ {C}_{k} ] ]}{{\sum }_{k , \underline{x} ∈ I} {w}_{k} ( \underline{x} )} . \qquad ( Equation 25 )$$

### Soft-Weights

In another example, the pruning carried out by Equation 22 can be implemented using soft weights.

In another example, the soft-weights may be computed using exponential weighting, where

$${w}_{k} ( \underline{x} ) = exp ( - {}_{{σ}_{k}}^{\frac{ω}{2}}{( \underline{x} - {\underline{c}}_{k} )}{}_{}^{T} {\underline{M}}_{k}^{- 1} ( \underline{x} - {\underline{c}}_{k} ) ) . \qquad ( Equation 26 )$$

In another example, the soft-weights may be computed using inverse weighting, where

$${w}_{k} ( \underline{x} ) = \frac{{σ}_{k}^{2}}{{( \underline{x} - {\underline{c}}_{k} )}^{T} {\underline{M}}_{k}^{- 1} ( \underline{x} - {\underline{c}}_{k} )} . \qquad ( Equation 27 )$$

### Experiments

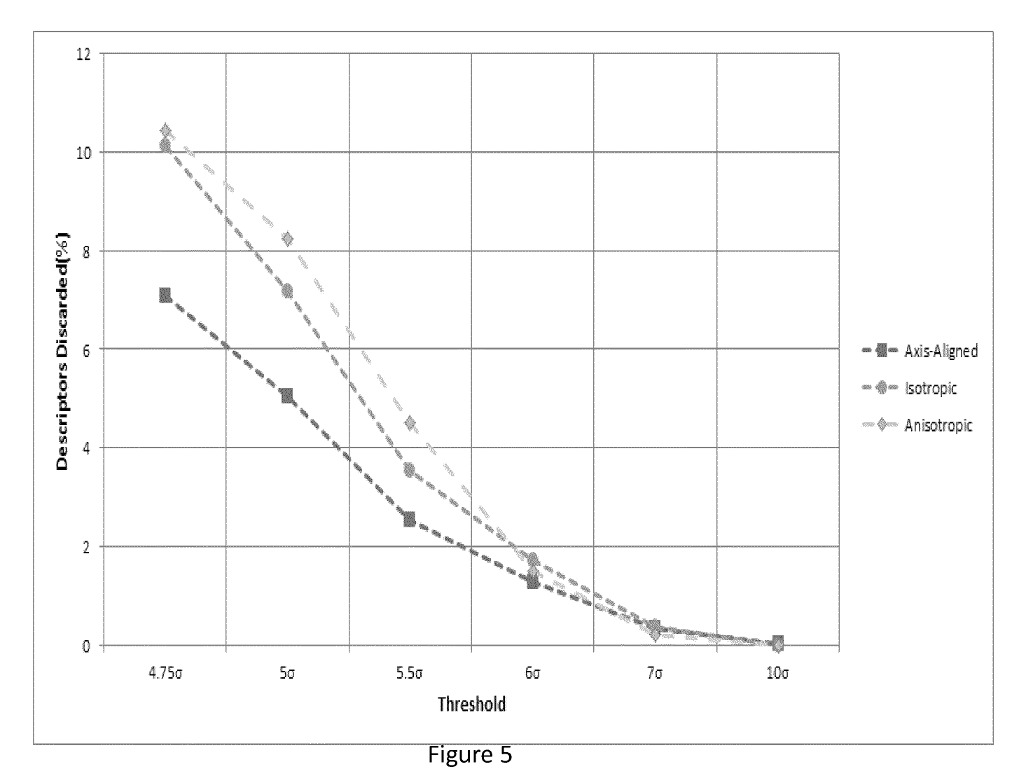

FIG. 5 illustrates an exemplary plot of percentage of Hessian-Affine SIFT descriptors that are pruned versus threshold values. The X axis pertains to square root of the threshold γσₖ² in Equation 24. The Y axis pertains to the percentage of local descriptors from the training set of local descriptors for which the condition in Equation 24 is true.

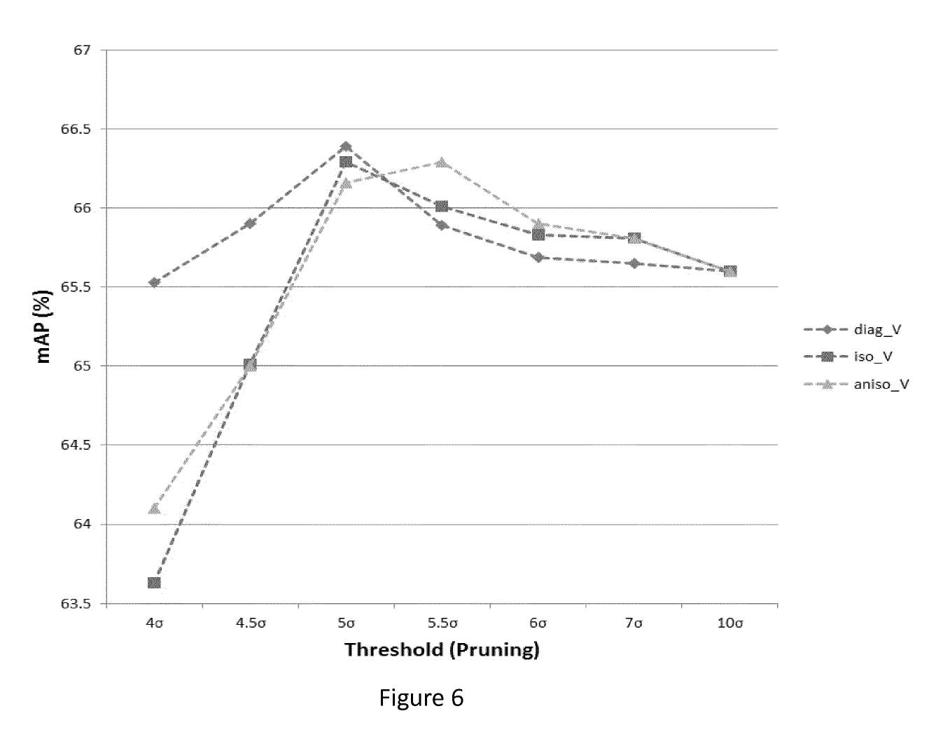

FIG. 6 illustrates a example of a plot that may be used to select the threshold parameter γ in Equation 24 when doing hard pruning. The X axis pertains to the square root of the threshold γσₖ² on the right hand side of Equation 24. The Y axis pertains to image retrieval performance measured as mean Average Precision (mAP) and computed over the Holidays image dataset.

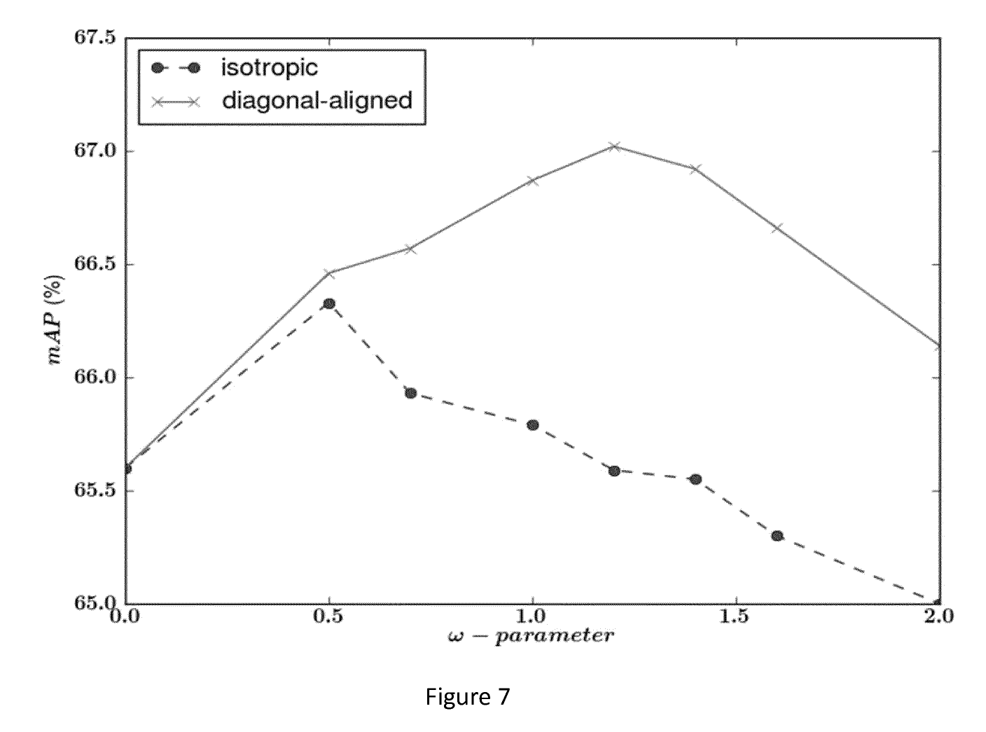

FIG. 7 illustrates an example of a plot that could be used to select the parameter ω required for soft pruning in Equation 26. The X axis pertains to the value of ω and the Y axis pertains to the image retrieval performance measure mAP computed over the Holidays image dataset.

The experiments underlying FIGS. 5-7 are carried out using the VLAD feature encoder with soft or hard pruning. The experiments underlying FIGS. 5-7 utilize SIFT descriptors extracted from local regions computed with the Hessian-affine detector or from a dense-grid detector. The RootSIFT variant of SIFT is utilized when using the Hessian affine detector.

The experiments underlying FIGS. 5-7 utilize a training set that is a Flickr60K dataset is composed of 60,000 images extracted randomly from Flickr. This data set is used to learn the codebook, rotation matrices, per-cluster pruning thresholds and covariance matrices for the computation of the Mahalanobis metrics.

The experiments underlying FIGS. 5-7 utilize for testing the INRIA Holidays dataset which contains 1491 high resolution personal photos of 500 locations or objects, where common locations/objects define matching images. The search quality in all the experiments is measured using mAP (mean average precision). All the experiments underlying FIGS. 5-7 have been carried out using a codebook of size 64.

Table 1 provides a summary of results for all variants, where each variant is specified by a choice of weight type (hard, exponential or inverse), metric type (isotropic, anisotropic or axes-aligned), and local detector (dense or Hessian affine).

TABLE 1

| | mAP (%) | | | | |
|---|---|---|---|---|---|
| Descriptors | baseline | Weights | Iso | Aniso | Ax-align |
| Hessian Affine | 65.60 | Hard | 66.29 | 66.29 | 66.40 |
| | | Inverse | 66.40 | 66.39 | 66.55 |
| | | Exponential | 66.45 | 66.40 | 67.02 |
| Dense | 72.71 | Hard | 73.34 | 73.37 | 73.56 |
| | | Inverse | 73.45 | 73.45 | 73.60 |
| | | Exponential | 73.69 | 73.61 | 74.28 |

The best result overall is obtained using axis-aligned exponential weighting (74.28% and 67.02% for dense and Hessian affine detections, respectively). Nonetheless, hard pruning yields improvements relative to the baseline, and one should note that it is less-computationally demanding than soft pruning. The best mAP for hard-pruning is obtained using the axes-aligned approach for both the dense and Hessian affine detectors (66.40% and 73.56% respectively). As illustrated in FIG. 7, keeping the parameter co equal to 1.0 provides good results.

Numerous specific details have been set forth herein to provide a thorough understanding of the present invention. It will be understood by those skilled in the art, however, that the examples above may be practiced without these specific details. In other instances, well-known operations, components and circuits have not been described in detail so as not to obscure the present invention. It can be appreciated that the specific structural and functional details disclosed herein may be representative and do not necessarily limit the scope of the present invention.

Various examples of the present invention may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language

1. An image processing system for processing an image for image searching comprising,
a memory;
a processor;
a local descriptor pruner configured to prune at least a local descriptor based on a relationship of the local descriptor and a codeword to which the local descriptor is assigned;
wherein the local descriptor pruner determines a weight value for the local descriptor based on a distance between the local descriptor and the codeword or based on a probability value produced by a Gaussian Mixture Model (GMM) used for an encoder and evaluated at the local descriptor, and removes said local descriptor if said distance or said probability value exceeds a threshold and wherein the weight value for the local descriptor is utilized by an image encoder during encoding when said local descriptor is not removed.

2. The image processing system of claim 1, wherein the local descriptor pruner determines a hard weight value that is either 1 or 0.

3. The image processing system of claim 1, wherein the local descriptor pruner determines a soft weight value that is between 0 and 1.

4. The image processing system of claim 3, wherein the local descriptor pruner determines the soft weight value based on either exponential weighting or inverse weighting.

5. (canceled)

6. The image processing system of claim 1, wherein the local descriptor pruner determines the weight based on the following equation wₖ(x)=[[(x−cₖ)^{T}Mₖ⁻¹(x−cₖ)≦γσₖ²]], wherein k is an index value, x is the local descriptor, cₖ is the assigned codeword, and γ, σₖ, and Mₖ are parameters computed prior to initialization, and [[ . . . ]] is the evaluation to 1 if the condition is true and 0 otherwise.

7. (canceled)

8. The image processing system of claim 1, wherein the local descriptor pruner determines the weight based on a parameter that is computed from a training set of images.

9. The image processing system of claim 1, wherein the image encoder is at least one selected from the group of a Bag of Words encoder, a Fisher Encoder or a VLAD encoder.

10. The image processing system of claim 1, further comprising an image searcher configured to retrieve at least an image result based on the results of the image encoder.

11. The image processing system of claim 1, further comprising a local descriptor extractor configured to compute at least an image patch and configured to extract a local descriptor for the image patch.

12. A method for image processing for processing an image for image searching comprising
pruning a local descriptor based on a relationship of the local descriptor and a codeword to which the local descriptor is assigned;
wherein the pruning of the local descriptor includes determining a weight value for the local descriptor based on a distance between the local descriptor and the codeword or based on a probability value produced by a Gaussian Mixture Model (GMM) used for an encoder and evaluated at the local descriptor, and removing said local descriptor if said distance or said probability value exceeds a threshold and wherein the weight value for the local descriptor is utilized during encoding of the pruned local descriptor when said local descriptor is not removed.

13. The method of claim 12, wherein pruning of the local descriptor includes determining a hard weight value that is either 1 or 0.

14. The method of claim 12, wherein pruning of the local descriptor includes determining a soft weight value that is between 0 and 1.

15. The method of claim 14, wherein the soft weighting value is determined based on either exponential weighting or inverse weighting.

16. (canceled)

17. The method of claim 12, wherein the weight is determined based on the following equation wₖ(x)=[[(x−cₖ₎^{T}Mₖ⁻¹(x−cₖ)≦γσₖ²]], wherein k is an index value, x is the local descriptor, cₖ is the assigned codeword, and γ, σₖ, and Mₖ are parameters computed prior to initialization and [[ . . . ]] is the evaluation to 1 if the condition is true and 0 otherwise.

18. (canceled)

19. The method of claim 12, wherein the weight is determined based on a parameter that is computed from a training set of images.

20. The method of claim 12, wherein the encoding of the pruned local descriptor is performed using at least one from the group of a Bag of Words encoder, a Fisher Encoder or a VLAD encoder.

21. The method of claim 12, further comprising searching at least an image result based on results of the encoding.

22. The method of claim 12, further comprising receiving an image and computing at least an image patch for the image.

23. Electronic device incorporating the image processing system of claim 1.

24. Electronic device of claim 23 selected from the group consisting of a computer, a laptop, a smartphone, a handheld computing system, and a remote server.

25. Non-transitory storage medium carrying instructions of program code for executing steps of the method of claim 12 when said program is executed on a computer
